(19) United States
(12) Patent Application Publication
(10) Pub. No.: US 2003/0030800 A1
(43) Pub. Date: Feb. 13, 2003

(54) Method and system for the determination of arsenic in aqueous media

(76) Inventors: Josh H. Golden, Santa Cruz, CA (US); Hugh E. Gotts, San Jose, CA (US); Jay Jung, Sunnyvale, CA (US); Marc Van Den Berg, Saratoga, CA (US)

Correspondence Address: DORSEY & WHITNEY LLP, Four Embarcadero Center, Suite 3400, San Francisco, CA, 94111-4187, US

(21) Appl. No.: 10/196,001

(22) Filed: Jul. 15, 2002

Related U.S. Application Data
(60) Provisional application No. 60/305,650, filed on Jul. 15, 2001.
(60) Provisional application No. 60/305,651, filed on Jul. 15, 2001.
(60) Provisional application No. 60/305,760, filed on Jul. 15, 2001.

(51) Int. Cl. G01J 3/44

(52) U.S. Cl. 356/301

(57) ABSTRACT

A Raman spectroscopy method and system for quantifying the concentration of arsenic and/or other aqueous solution constituents. A variety of spectroscopy probe configurations and a chemical auto-dosing system are provided as well as a method for deconvoluting a spectrum with overlapping peaks to identify and quantify the concentrations of individual constituents of the solution based on a single spectrum.

### RELATED APPLICATIONS

This application claims priority to U.S. Provisional Applications Serial Nos. 60/305,650; 60/305,651; and 60/305,760, all filed on Jul. 15, 2001, the disclosures of which are hereby incorporated by reference in their entireties. This application is related to copending U.S. patent application ______: Method and System for Analyte Determination in Metal Plating Solutions (Attorney Docket No. A-70454/MSS/MDV), the disclosure of which is incorporated herein by reference.

### FIELD OF THE INVENTION

The present invention relates generally to the field of arsenic detection and arsenic bearing wastewater treatment and analysis. More specifically, the present invention is related to a method and system for determining the presence of arsenic in aqueous media using Raman spectroscopy, and using said method to control an arsenic remediation process.

### BACKGROUND

Treatment and removal of arsenic in both industrial wastewaters and potable water sources in the U.S. and worldwide has recently gained widespread notice, due to the carcinogenic properties of aqueous arsenic, as well as the ongoing debate regarding establishment of a revised maximum contaminant level (MCL) standard for arsenic that is both reasonably attainable and adequately protective of human health. The MCL currently imposed by the United States Environmental Protection Agency is 10 parts per billion (ppb or mg L⁻¹). Promulgation of a new, more stringent MCL is expected to bring new and more efficient arsenic removal technologies to the forefront, while creating new commercial opportunities in both potable and industrial water applications. In addition to improved treatment methods for arsenic removal from aqueous media, there is also a need for an efficient real time in situ method for arsenic determination in aqueous systems and furthermore for automated remediation process control technologies in both potable and industrial applications.

Arsenic occurs in 4 valence states: −3, 0, +3, and +5. In most waters, the +3 and +5 oxidation states are respectively found as the AsO₃³⁻ (arsenite) and AsO₄³⁻ (arsenate) anions. Arsenate is the most common form of soluble arsenic in semiconductor processing waste waters. Compounded solid arsenic in the form of GaAs particles may be obtained from ingot processing and dicing operations. The arsenate anion is negatively charged at low pH values because it is the anion of a strong acid, o-arsenic acid (H₃AsO₄, pKₐ₁=2.20). In contrast, arsenite (AsO₃³⁻) removal by absorption and coagulation is less effective because its main form, arsenious acid (H₃AsO₃), is a weak acid (pKₐ₁=9.23), and is only partially ionized at pH values where removal by absorption occurs most effectively (pH 5-8). To insure that the arsenic is in the +5 oxidation state, the water may be treated with oxidants including chlorine or permanganate. Absorption of arsenate anion and other negatively charged and partially protonated species by aluminum and ferric hydroxide gels between pH 5 and 8 remains the predominant form of treatment. This is typically achieved by direct injection of acidic aluminum or ferric chloride solutions into the wastewater with the appropriate pH adjustment. The arsenate anion (AsO₄³⁻) remains negatively charged even at low pH values, and is thus effectively absorbed and removed by the ferric or aluminum hydroxide gels. The pH dependent absorption of arsenate anion by ferric hydroxide is shown in FIG. 1. The decrease in arsenate absorption above pH 8 is due to the formation of a negatively charged ferric hydroxide surface which repels negatively charged arsenate.

A variety of new arsenic removal technologies have been proposed and are the subject of intense research. However, coagulation and precipitation by aluminum and ferric salts remains the most widely used method. Arsenic removal technologies are reviewed in greater depth in for example: Proceedings of the Inorganic Contaminants Workshop, AWWA, Feb. 27-29, 2000; J. Hering, et al. Arsenic Removal by Ferric Chloride, Jour. AWWA, 1996, 88, pp. 155-167; J. Hering, M. Elimelech, Arsenic Removal by Enhanced Coagulation and Membrane Processes, AWWA Research Foundation, Denver, Colo., 1996; L. G. Twidwell, et al., “Technologies and Potential Technologies for Removing Arsenic from Process and Mine Wastewater,” Proceedings of the REWAS Global Symposium on Recycling, Waste Treatment, and Clean Technology, 1999, pp.1715-1726, Minerals, Metals, and Materials Society, Warrendale, Pa.

One industrial wastewater application where arsenic detection and removal is extremely important involves effluent obtained from the semiconductor manufacturing. The rapidly increasing use of compound semiconductors derived from the elements found in group 3 and group 5 of the periodic table is driven by the demand for high speed application specific integrated circuits (ASICs), solar cells, light emitting diodes, and lasers diodes. Examples of “3/5” compounds used in these and other applications include GaN, InGaN, InP, GaAlP, InGaAsP, and GaAs. Of particular interest are semiconductor and semiinsulator devices based on gallium arsenide (GaAs) due to several intrinsic GaAs advantages over silicon. For example, GaAs electron mobility is approximately a factor of six greater than that of silicon, which results in faster response to external radiation signals and clock-speeds two to three times greater than that of comparable silicon-based devices. Higher speeds are also indirectly realized from the larger GaAs bandgap (1.424 eV) versus that of Si (1.1 eV), which results in reduced parasitic capacitance within the device. These properties make GaAs devices ideal candidates for high frequency and high temperature applications in broadband telecom, datacom, optical, and solar cell applications.

GaAs single crystals are typically produced by the Czochralski method in which ingots are pulled from a melt of the elements at elevated temperatures. Arsine (AH3) gaseous byproduct may be suppressed by a low density barrier layer floating on top of the GaAs melt. Epitaxial growth of extremely pure GaAs is commonly achieved by metal organic chemical vapor deposition (MOCVD), as shown in equation 1:

(CH₃)₃Ga+AsH₃→GaAs+3CH₄ (1)

Destruction of arsine gas, phosphine (PH₃) gas, and volatile organogallium and indium compounds from 3/5 semiconductor synthesis and ion implantation processes are achieved by oxidative combustion in a point of use (POU) thermal processing unit (TPU). In a typical TPU, in the presence of oxygen, methane gas serves as the primary fuel to maintain continuous combustion at temperatures ranging from 750 to 1000° C. The 3/5 compound precursors are fed into the TPU at flow rates as high as 1000 standard cm³ min⁻¹ (sccm) to produce fully oxidized intermediate products such as As₂O₅, P₂O₅, Ga₂O₃, and In₂O₃. These hot and corrosive intermediate products are then exposed to cold water in a POU wet scrubber for conversion to hydrated oxides and/or hydroxides (group 3 oxides) and water soluble acids (group 5 oxides). The following two chemical equations illustrate the conversion of arsine gas to arsenic acid:

2AsH₃+3O₂→As₂O₅+H₂O+4H⁺ (2)

As₂O₅+3H₂O→2H₃AsO₄ (3)

POU water scrubbers found in a typical fab are generally of the packed tower and sieve tray type, with recirculation flow rates of up to 50 gallons per minute (gpm). Chemical species of particular concern in scrubber aqueous waste streams (with flow rates of approximately 1-2 L min⁻¹) are phosphoric acid (H₃PO₄) and arsenic acid (H₃AsO₄), and their related pH-dependent anions. Respective average concentrations of these species in scrubber effluent are approximately 1000 to 1700 parts per million (ppm) over 24 hours at a gaseous precursor flow rate of 1000 sccm. In addition to wet scrubbers, arsenic-bearing aqueous effluents from compound semiconductor processing are obtained from slicing, dicing, and etch processes. Generally, the flow rates of these contaminated waters can vary from approximately 1 gpm to 50 gpm or more, again depending on dilution factors and wastewater blending schemes.

A variety of methods have been developed to determine arsenic in wastewaters and potable waters. Sensitivity ranges from parts per billion to many g L⁻¹. These techniques include:

Absorption spectroscopy

Ion-selective electrode methods

Atomic fluorescence spectroscopy

Neutron activation analysis

Atomic emission spectroscopy

Atomic absorption spectroscopy

Gas chromatography

High performance liquid chromatography.

All of these methods have their strengths and their limitations. What they do have in common is that none of these methods are real-time or in situ. For example, determination of arsenic by ultraviolet-visible absorption spectroscopy typically involves the treatment of a water sample to form a colored complex which is then analyzed in a spectrophotometer. Two methods are well established. One involves a blue chromophore complex based on the hetero-acid related to molybdenum blue (heteropoly blue) and the other involves a red chromophore complex with silver diethyldithiocarbamate (SDDC). These chemical derivatization methods require several steps, and are most efficiently performed in a laboratory with special apparatus. These methods are time consuming, are not readily adaptable to in situ analysis, and do not give quantitative results in real time. Some of these techniques may also require the handling of organic solvents and toxic reagents.

Ion selective electrodes have also been proposed for arsenic detection, but suffer from interferences from similar oxo-anions such as phosphate, and may require a pre-derivatization step such as titration. This method requires significant skill in the art of electrochemistry to interpret the results. Other methods for arsenic detection such as atomic absorption, emission, neutron activation, and chomatography suffer from the need for costly and bulky equipment in a laboratory environment. The techniques also require sample dilution and typically require 20 minutes to one hour to obtain results. Because of these drawbacks, there is a need for a rugged, less costly, real-time, in situ quantitative method for arsenic detection in industrial wastewaters and in potable waters. It is also desirable that such a system have a small footprint.

Ideally, an in situ, real-time method for arsenic analysis would continuously monitore the concentration of arsenic, and include a feedback loop to a system for arsenic removal via autodosing of appropriate removal chemicals to ensure that the remediation process is stable. Spectroscopic methods are direct, with results obtained in real-time and thus can be used for real-time process control with minimal lag time. A direct in situ spectroscopic method is clearly preferable to an indirect method such as titration, atomic absorption, or electrochemical analyses. However, because aqueous solutions include water as the solvent and contain dissolved metal ions and/or complexes, typical spectroscopic absorption techniques are of little to no utility. For example, UV-visible and infrared (IR) spectroscopic techniques have severe limitations in detecting arsenic because aqueous solutions are highly absorbing in the several regions of the IR and UV-visible range, and thus tend to interfere with the detection of a arsenic species that has been chemically derivatized. Moreover, UV-visible detection of derivatized arsenic must be performed under tightly controlled conditions in which proper pH is maintained and the complex is deemed stable over a particular time period of approximately 15 minutes. Infrared spectroscopy is not a useful technique because water has a very strong —OH vibrational band at about 3500 cm⁻¹ that obscures most useful chemical information.

Raman spectroscopy is a spectroscopic technique that works well in an aqueous environment with little interference from the water solvent. Raman spectroscopy operates on the principle that light of a single wavelength striking a molecule is scattered by the molecule through a molecular vibration state transition. The resultant scattered light has wavelengths different than the incident or excitation light. The wavelengths present in the scattered light are characteristic of the structure of the molecule. The intensity and wavelength or “Raman Shift” of the scattered light is representative of the concentration of the molecules in the sample. Raman spectroscopic analysis interrogates polarizability changes in the molecule to determine the presence or absence of molecular bonding, and by inference, the chemical species. Approximately 1 part in 1 million of the incident light is scattered. When a photon of incident light interacts with a molecule, in most cases, this interaction leads to the molecule assuming a more excited (higher energy) vibrational state with the emission of a photon at a longer (less energetic) wavelength. Because a small fraction of molecules in any sample already exist in an excited vibrational state, some interactions between an incident photon and a molecule may lead to a decrease in the molecule's vibrational energy state with a concomitant emission of a photon at a shorter (more energetic) wavelength. These Raman effects, including resonance Raman spectroscopy (RRS), surface enhanced Raman spectroscopy (SERS) and surface enhanced resonance Raman spectroscopy (SERRS) are generally described in greater detail in Grasselli et al., Chemical Applications of Raman Spectroscopy, Wiley-Interscience, John Wiley and Sons, New York, 1981. In addition, a variety of Raman spectroscopy devices have been developed in the industry. For example, a fiber optic type device is described in Angle, S. M., Vess T. M., Myrick, M. L., Simultaneous multipoint fiber optic Raman sampling for chemical process control using diode lasers and a CCD detector, SPIE vol. 1587, p. 219-231, Chemical, Biochemical, and Environmental Fiber Sensors III, 1992.

Many important molecular functional groups are inactive or weak in absorption processes, but show significant activity in Raman spectroscopy. These functional groups include, but are not limited to, carbon-carbon bonds; metals and semi-metal oxygen bonds (arsenate or arsenite); and other main group oxyanions such as sulfate, phosphate, and nitrate. A preferred Raman sensitive functionality has the proper symmetry of chemical bonds so that a strong Raman response is obtained. Raman responses are typically characterized as being in the range from weak (lowest sensitivity) to very strong (highest sensitivity). For example, the Raman sensitive functionality may comprise a chemical group, such as for example a nitrile or a quaternerized amine, that has a strong scattering response in a wavelength range where water scattering does not occur. Other Raman sensitive groups may include, among others, carbonyls, ketones, hydrazones, saturated and unsaturated carbon, alcohols, organic acids, azo, cyanates, sulfides, sulfones, and sulfonyls. A great variety of organic and inorganic compounds yield useful Raman signals. A large variety of transition metal oxo-anions and complexes, as well as ions selected from the main-group elements also have a good Raman scattering response. Examples include, but are not limited to, arsenate, tungstate, sulfate, nitrate, phosphate, and borate.

While Raman spectroscopy has been described, in current applications it suffers from many difficulties that limit its usefulness in commercial applications. One significant problem with Raman spectroscopy is the low intensity of the scattered light compared to the incident light. Isolating, amplifying and processing the scattered light signal typically requires elaborate and costly equipment. A further problem is interference with the Raman signal due to fluorescence, or emission of light due to electronic state transitions, from a solution or composition under analysis. Many compounds fluoresce or emit light when exposed to laser light in the visible region. Fluorescence bands are generally broad and featureless, and the Raman signal can often obscured by the fluorescence. Again, complicated and costly sensors and signal processing equipment are needed to process the signal.

Additional problems with Raman spectroscopy include overlapping peaks of multiple compounds in a sample being analyzed and solution self-absorption. When a variety of compounds are present in a sample to be analyzed, all of the compounds contribute to the Raman signal. Determining and quantifying chemical analytes in solutions on a real time basis in an industrial setting requires a method and system capable of identifying the analytes despite spectral interference from one or more other compounds present in the aqueous solution. In solutions with strong absorbance at or near the wavelength of the incident light, the strength of the resultant Raman signal is decreased due to absorption of both the incident light and Raman scattered light by the solvent and solution components. Attenuation of the incident light degrades the intensity of the Raman interactions of irradiated molecules by decreasing the incident photon flux while absorption of the scattered light increases the difficulty of extracting useful species identification and quantification information from the background spectral noise. Thus, further developments in Raman spectroscopy systems and methods are needed.

### SUMMARY OF THE INVENTION

Accordingly, it is an object of the present invention to provide a method and system for identifying the presence of arsenic in aqueous solutions. More specifically, the present invention provides a method and system for determining the presence and/or concentration of arsenic in aqueous solutions using Raman spectroscopy. The present invention also provides a system and method of controlling via a feedback loop the automatic autodosing of chemical reagents into the wastewater as needed to remove arsenic and maintain optimal wastewater remediation process parameters.

In one embodiment of the present invention, a Raman spectroscopy system for quantifying concentrations of arsenic is provided. The system includes a monochromatic light source that provides incident monochromatic light at a wavelength chosen to fall within a region of low light absorbance on the ultraviolet-visible light absorbance spectrum for the aqueous solution. A detector for detecting an emission spectrum of Raman scattered light from the aqueous solution is also provided. Incident monochromatic light is conducted to the sample via a probe assembly that comprises an immersible head. The immersible head includes a probe window that is transparent to the chosen incident monochromatic wavelength as well as to wavelengths at which Raman emissions are expected. In operation, the immersible head is immersed in a subvolume of the solution such that the probe window is completely submerged to exclude ambient light. A first fiber optic cable transmits the incident monochromatic light from the source to the immersible head from which it is directed into the sample subvolume through the probe window to produce an emission spectrum of Raman scattered light with peaks at one or more scattered wavelengths. A second fiber optic cable transmits Raman scattered light that passes into the immersible head through the probe window from the immersible head to the detector. Each of the arsenic emission spectrum peaks has an associated area and a height. These areas are input into a spectrum processor that calculates the concentration of the arsenic using a linear algebra-based method to deconvolute the peaks in the solution emission spectrum of Raman scattered light based on pre-calculated ratios of the areas under a plurality of peaks in a standard emission spectrum for the aqueous solution contaminants.

In a further embodiment of the present invention, a method is provided for quantifying the concentration of arsenic in an aqueous solution. A standard emission spectrum is collected for aqueous arsenic. Based on these standard spectra, a ratio of peak areas or heights between each of the resultant peaks in each spectrum is calculated. Incident monochromatic light at a chosen wavelength is transmitted from a monochromatic light source to a sample of the aqueous solution. The wavelength of the monochromatic light is selected to fall within a region of low light absorbance on an ultraviolet-visible light spectrum collected for the aqueous solution. The incident monochromatic light from the source is conducted via a first fiber optic cable to an immersible probe submerged in the aqueous solution sample. The focal point of the incident laser light is adjusted such that its penetration depth into the sample is in the range of approximately 0.1 mm to 1 cm. Light emitted by Raman scattering in the sample subvolume is received by the immersible head and transmitted to a light detector via a second fiber optic cable which detects the emitted light and converts it into an aqueous solution emission spectrum. The resultant aqueous solution emission spectrum is analyzed to quantify the concentrations of aqueous solution chemical species in the subvolume by creating a series of coupled linear equations in which the concentrations of the aqueous species are unknowns and the pre-calculated peak area or height ratios are knowns. The set of linear equations is solved using linear algebra or other applicable methods of analysis.

### BRIEF DESCRIPTION OF THE DRAWINGS

Other objects and advantages of the present invention will become apparent upon reading the detailed description of the invention and the appended claims provided below, and upon reference to the drawings, in which:

FIG. 1 is a chart showing arsenic removal by absorption with ferric hydroxide as a function of pH.

FIG. 2 is a chart showing a Raman spectrum of an aqueous solution containing arsenic.

FIG. 3 is a schematic diagram illustrating the Raman device of according to one embodiment of the present invention.

FIG. 4 is a schematic diagram showing a more detailed view of a sampling probe according to one embodiment of the present invention.

FIG. 5 is a schematic diagram showing a more detailed view of a flow cell according to one embodiment of the present invention.

FIG. 6 is a schematic diagram showing a detail of a probe head with a ball lens according to one embodiment of the present invention.

FIG. 7 is a schematic diagram showing a detail of a probe head with an adjustable focal length lens according to one embodiment of the present invention.

FIG. 8 is a graph showing an prototypical example of a Raman calibration curve of peak area vs. concentration for an arsenic aqueous solution.

FIG. 9 is a flow chart showing the steps by which a spectrum of overlapping peaks is deconvoluted to calculate concentrations of multiple analytes.

FIG. 10 is a schematic diagram showing an integrated aqueous arsenic analyzer system according to one embodiment of the present invention.

FIG. 11 is a graph illustrating the detection of arsenic in accordance with one embodiment of the method and system of the present invention.

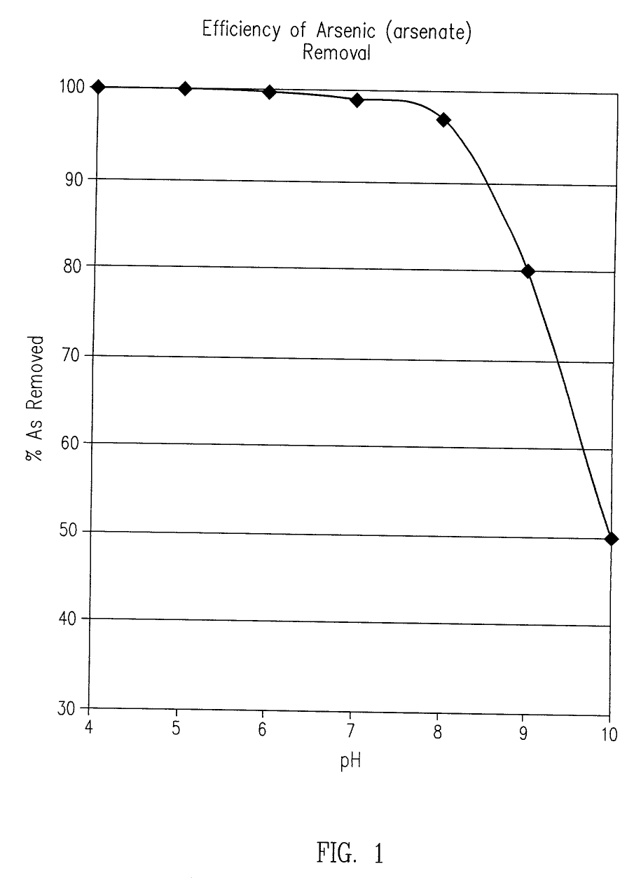

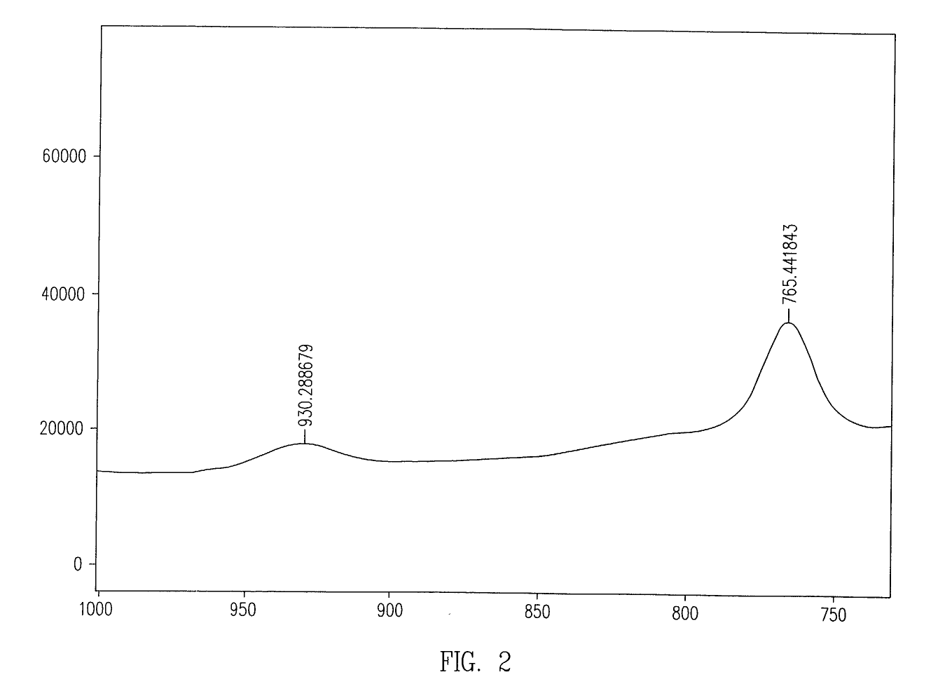

### DETAILED DESCRIPTION OF THE INVENTION

The present invention provides a method and system for identifying chemical analytes in solutions. More specifically, the present invention provides a method and system for determining the presence and/or concentration of arsenic in solutions using Raman spectroscopy.

The present invention provides a rapid and real-time method and system of quantifying organic and inorganic species in aqueous solutions and, in a further embodiment, of automatically replenishing the concentrations of additives used to precipitate or remove arsenic from solution in response to the measurements. Concentrations of these species may be in the ppm (part per million) range or in the grams per liter range. More specifically, the present invention provides a methodology and system for the quantification of aqueous arsenic in wastewaters and potable waters over a broad concentration range. The present invention provides a method for detection and quantification that employs Raman spectroscopy in conjunction with inventive techniques that diminish or eliminate photon absorbance characteristics of the aqueous system that can interfere with accurate detection of analytes of interest. The Raman spectroscopy system and method of the present invention provides rapid and quantitative measurement of relatively dilute organic and inorganic species which are extremely difficult to quantify in real time using prior art methods.

First discovered by C. V. Raman in 1928 (Nature (London), v. 121, p. 501 (1928)), Raman spectroscopy has great potential as a novel and efficient method for real-time quantitative analysis of chemicals as solids, slurries, or in solution. In general, Raman spectroscopy involves the scattering of incident light by molecules. While most of the incident radiation is scattered elastically, a small fraction of photons return with higher or lower energy, usually 1 in 1 million or so. A net loss of photon energy (increase in wavelength) results from the photon's induction of a molecular vibration in a molecule it encounters. In contrast, a gain in energy (decrease in wavelength) by the photon is a result of the absorption of a molecular vibration by the photon interacting with a previously excited molecule that drops to a less energetic vibrational state as a result of the interaction. Formally, the photon interactions are a result of a change of molecular bond polarizability (P) due to the interaction with a photon's electric field (E), as expressed in equation 1:

P=aE (4)

The Raman effect increases in strength at shorter incident light wavelengths Observed Raman peaks are typically shifted to lower energies than the incident radiation (Stokes shift). This is due to the higher probability of a change in polarizability, or vibrational transition at room temperature, because most of the molecules are at a lower energy vibrational state. However, the photon can interact with a small fraction of high energy vibrational states that are also populated, resulting in emission of a higher energy photon (anti-Stokes shifted). Raman response is also dependent on laser wavelength. Signal intensity I, is dependent on wavelength (X), as expressed in equation 2:

I≈λ⁻⁴ (5)

According to equation 2, a 532 nm laser yields approximately 5 times greater Raman response intensity than a 785 nm laser. Therefore the inventors have discovered that it is advantageous to choose a higher energy laser to promote greater signal to noise ratio and shorter spectrum acquisition times. However, the higher energy of lower wavelength photons can also induce fluorescence emissions which may mask the Raman response in some samples. According to the present invention, a further consideration in Raman spectroscopy is taught that, though the intensity of Raman signal is linearly dependent on the power of the incident light and it may in some cases be advantageous to employ a higher powered light source, sheer brute force application of additional incident radiation power may not be advantageous due to the potential for inducing undesirable physical and chemical changes in the sampled solution under high power density conditions.

Raman spectroscopy has significant advantages over absorption techniques such as UV-visible, near infrared and mid infrared, especially in aqueous solution analysis. Water is a weak Raman scatterer in the range of approximately 300 to 800 nm. However, non-Raman spectroscopic techniques may be overwhelmed by absorption of incident photons by dissolved ions or water itself due to its presence in overwhelming excess. An effective normalized range for Raman signals in wavenumbers is typically from 200 cm⁻¹ to 3000 cm⁻¹, which allows for the detection of a large variety of inorganic and organic species in aqueous media.

Identifying the window of relatively high transmission in the absorption spectrum of an aqueous solution allows a choice of incident laser light, preferably a diode laser source, that transmits light with a wavelength in the range of approximately 300 to 680 nm. If a laser is chosen that transmits radiation at or near the absorption maxima of the solution, the Raman effect is greatly diminished as photons that would otherwise be available to stimulate Raman emissions from the molecules of interest are attenuated by absorbance within the bulk fluid. Moreover, substantial solution absorption at the laser wavelength results in an exponential relationship between intensity and concentration, which is a significant source of error in quantitative detection of the analyte or analytes of interest. Therefore, it is important to choose the correct laser incident wavelength. In this embodiment of the present invention, an 84 mW green Nd:YAG laser source that transmits at 532 nm is used. The power of the laser is not limited, however, a range of 5 to 200 mW is preferred for best signal generation. A 532 nm diode laser source is preferred for the analysis of solutions because it emits within the window of solution light transmission and is compact and efficient. Those skilled in the art can select the correct wavelength of incident monochromatic light for other applications based on the teaching of the present invention.

In this embodiment of the present invention, a method and system for sensing analytes in solutions is provided wherein a Raman spectroscopy sensor is utilized. The Raman sensor generally includes a monochromatic light source to probe an aqueous solution containing one or more analytes. Generally, the solution is passed through a fluid path which intersects the light source. The monochromatic light source may be a diode laser, gas laser, filtered high intensity light source and the like. As the monochromatic light source probes the solution, light is scattered. Individual wavelengths of the scattered light are separated using a compact monochromator in either a static or scanning mode, with detection provided by a detector such as a high sensitivity CCD or diode array detector. Additionally, source photons may be carried to the solution utilizing a series of bundled fibers which return the light to the detector for subsequent evaluation.

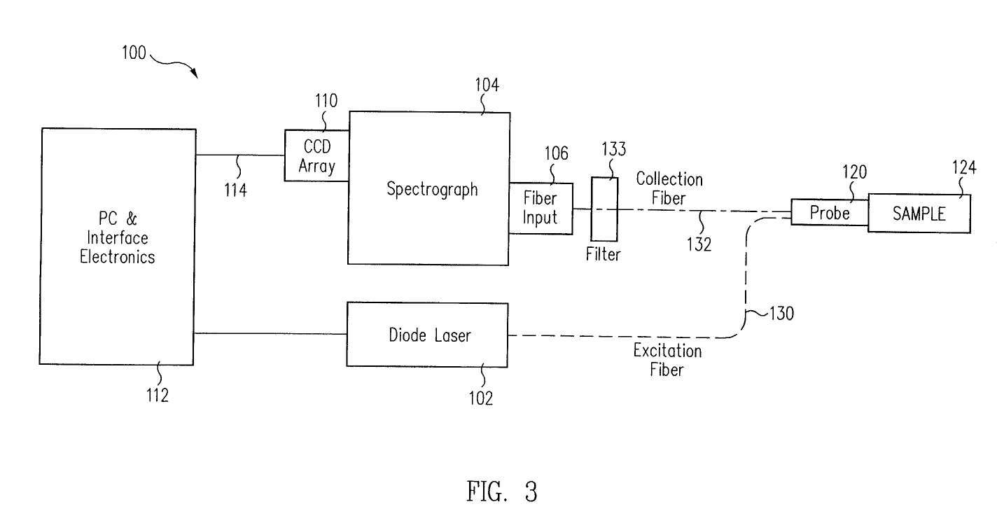

A Raman spectroscopy sensor 100, particularly suitable for detection of analytes in solutions, in accordance with this embodiment of the present invention is illustrated in FIG. 3. The sensor 100 generally includes a monochromatic light source 102, a spectrograph 104, a probe 120 that is coupled to the light source and spectrograph through an excitation fiber 130 and a collection fiber 132 respectively, for delivering incident light to and collecting scattered light from a sample 124, a fiber input 106 and CCD array 110 coupled to the spectrograph 104, and a personal computer data processor with interface electronics 112 for controlling the system and processing the output from the spectrograph 104.

In the exemplary embodiment shown in FIG. 3, the monochromatic light source 102 is preferably comprised of a frequency doubled YAG diode laser, operating at 20 mW, 0.1 nM stability with 1.5 mrad beam divergence. The diode laser is powered by a power supply (not shown) which preferably is 120 V temperature stabilized. In one embodiment, the excitation light from the diode laser is focused onto a fiber end of the excitation fiber 130 which conducts the incident light to the probe 120 for focusing into a sample subvolume 124. Preferably both the excitation fiber 130 and the collection fiber 132 are comprised of a poly-micro fiber optic cladded light guide.

A solution sample 124 to be analyzed enters the sample subvolume either through normal operating circulation of the bulk aqueous solution or via one or more pumps (not shown). The aqueous solution interacts with the excitation light delivered by the excitation fiber 130 to the probe 120 to yield Raman scattered light. Light scattered from the solution—the Raman radiation or signal—is collected by the probe 120 and delivered to the fiber input 106 via the collection fiber 132. From the fiber input 106, collected scattered light passes into the spectrograph 104 wherein it is analyzed to yield a spectrum which is quantified in real time via a CCD array 110.

The Raman signal preferably passes through a filter 133 which is preferably a reject filter chosen to filter out light at the incident wavelength to prevent swamping of the CCD detector, and is coupled via a SMA connection to fiber optic borosilicate glass, prior to analysis in the spectrograph. Borosilicate fiber has a Raman shift of a well defined wavelength notch for baseline frequency calibration. Various spectrographs 104 may be used. In one embodiment, the spectrograph is a CS400 Micropac with Hamamatsu 256Q cooled array. A serial interface 114 may be provided for coupling the processed signal to a computer system and interface electronics 112 for display and/or analysis.

The spectrometer is optical and mechanical in nature. The Raman scattered light delivered via the collection fiber 132 from the sample is projected onto the CCD array 110. A charge-coupled device (CCD) is a light sensitive integrated circuit that quantifies the intensity of the light by converting the light into an electrical charge. The CCD data or spectrum is then analyzed to calculate the concentration levels of additives and byproducts. The computer system 112 preferably consists of a computer, a CCD controller card that plugs into the computer mother board, communication PC cards such as a modem and an Ethernet card among others, and digital and analog input/output ports.

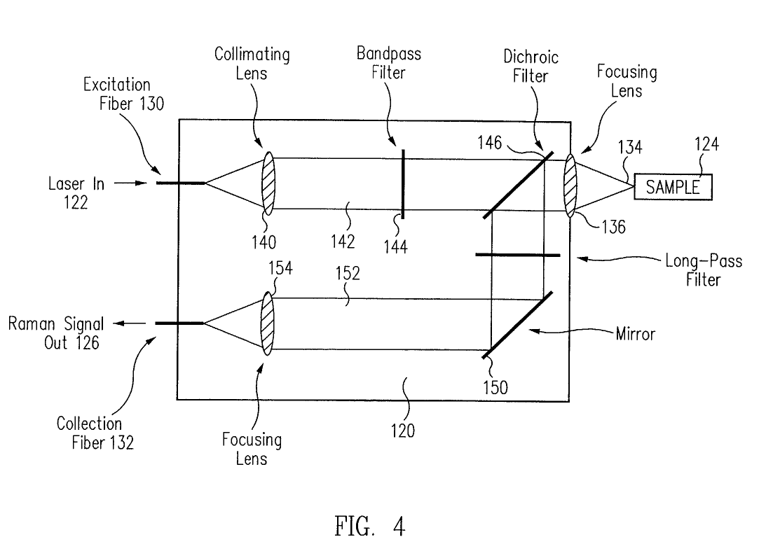

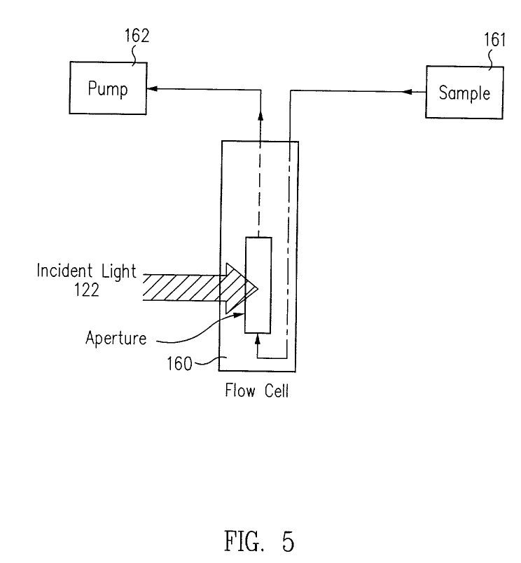

FIGS. 4 and 5 are schematic diagrams providing additional detail of an exemplary system according to one embodiment of the current invention. An immersible probe 120 that transmits the incident light 122 from a diode laser light source 102 to the analyte solution sample 124 and also receives the scattered signal 126 is used in this embodiment. Incident light 122 is transmitted from the monochromatic light source 102 to the probe via an excitation fiber optic cable 130. Scattered light is collected by the probe and transmitted to a fiber input 106 to a spectrograph 104 by a collection fiber optic cable 132. The focal point, or working distance 134 of the laser light 122 is adjusted so that its penetration depth into the solution sample 124 is preferably in the range of approximately 0.1 mm to 1 cm, with a range of approximately 0.1 to 5 mm most preferred. The working distance 134 is adjusted according to the turbidity of the solution as well as its self-absorption characteristics. The probe 120 is constructed of materials that resist the corrosive effects of an acidic aqueous environment such as, for example Monel alloy, Teflon, or other inert materials. A probe window or more preferably a lens 136 is provided through which incident and scattered light pass out of and into, respectively, the probe. This window or lens 136 is preferably constructed of either sapphire or quartz. The probe 120 is immersed into the aqueous solution or some other subvolume containing a sample such that ambient light is excluded. It is preferred that the probe 120 is immersed in a subvolume or region of the aqueous solution or test solution in which circulation past the probe is sufficient for continuous monitoring of a dynamic chemical environment that is representative of the aqueous solution as a whole. The probe 120 may be preferably placed in a pipe or some other custom built chamber with appropriate pumps to circulate the solution past the probe and prevent interference from ambient light.

FIG. 4 also shows additional details regarding a preferred embodiment of the probe. In a preferred embodiment of the present invention, an 84 mW green Nd:YAG laser source is provided that transmits at 532 nm in conjunction with a short path length quartz flow cell to reduce the absorbing characteristics of the solution. The sample 124 is housed in a pipe or chamber (not shown) that interfaces with the probe 120. In this embodiment, light conducted to the probe by the first or excitation fiber optic fiber 130 enters the chamber and passes through a collimating lens 140 which collimates the light. The collimated light beam 142 then passes through a bandpass filter 144 and a dichroic filter 146 before exiting the probe via a focusing lens 136 that focuses the light beam 142 on the sample 124 at the desired working distance 134. Light scattered from the sample 120 passes back through the focusing lens 136 into the probe 120 where the dichroic filter 146 diverts light that differs from the incident beam wavelength at a 90° angle to a mirror 150 angled at 45° to redirect the scattered light beam 152 parallel to the incident collimated beam 142. The scattered light passes through a second focusing lens 154 that focuses it into the second, collection fiber optic fiber 132 for transmittal to the detector.

Because absorbency is proportional to path length, the path length is chosen to minimize absorbance of the incident laser by the solution under analysis. A path-length that is too long may result in the capture of both incident laser light and the emitted Raman signal by the inherent absorbancy of the sample. A flow cell with a fixed path length as shown in FIG. 5 may preferably be used for continuous monitoring of the dynamic aqueous solution environment. Sample solution 161 is circulated through the flow cell 160 via pressure or aspiration by mechanical and/or micromechanical pumps 162. The flow cell path length may preferably be in the range of approximately 0.1 to 10 mm. More preferably, the flow cell path length through which incident light from the probe passes is in the range of approximately 0.1 to 1 mm. The cell preferably interfaces with a fiber optic probe of the same general design as shown in FIG. 4.

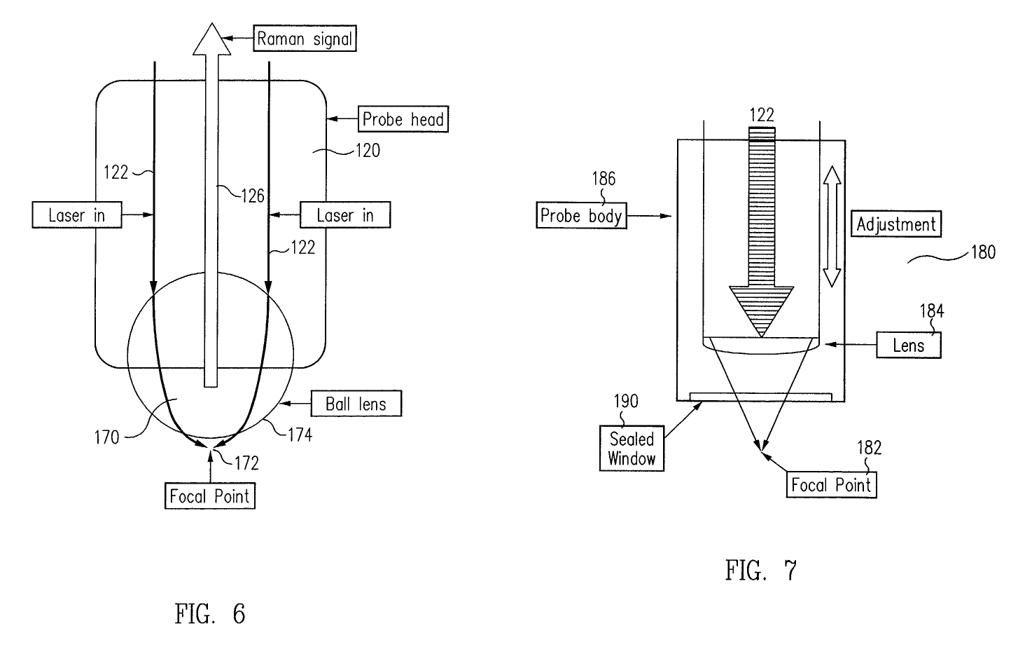

In another embodiment of the present invention, an immersible probe as shown in FIG. 4 is provided that includes a ball lens. Use of a ball lens provides the following advantages: the focal distance is always tangent to the ball lens surface and thus constant thereby providing a constant sample volume, the probe is always properly aligned when it is in contact with a sample, and there are no moving parts. A general schematic of an exemplary ball probe according to this embodiment is shown in FIG. 6 which includes a ball lens 170 having a focal point 172 on its surface 174. The ball lens 170 is mounted in a probe head 120 that includes appropriate optics (not shown) to convey an excitation beam of monochromatic light 122 to the ball lens 170 and a beam of scattered light 126 away from the ball lens and to an appropriate detector or detectors. In general, the ball lens 170 is housed in a barrel-shaped probe that is preferably constructed of materials such as for instance Monel alloy, Teflon, or other inert, acid resistant materials. The ball lens is preferably constructed of sapphire or quartz or other materials that are both acid resistant and transparent to the incident and scattered light wavelengths. Because the ball lens probe has its focus at the surface of the sphere, constant sampling precision and repeatability is enhanced. It is preferable to position the probe in contact with the aqueous solution such that ambient light is excluded and where circulation of the aqueous solution past the probe is sufficient to allow for continuous monitoring of the dynamic chemical environment within the bulk of the aqueous solution. The probe is thus preferably placed in a pipe or chamber or other customized subvolume equipped with appropriate pumps to circulate a sample of the aqueous solution past the ball lens and exclude ambient light.

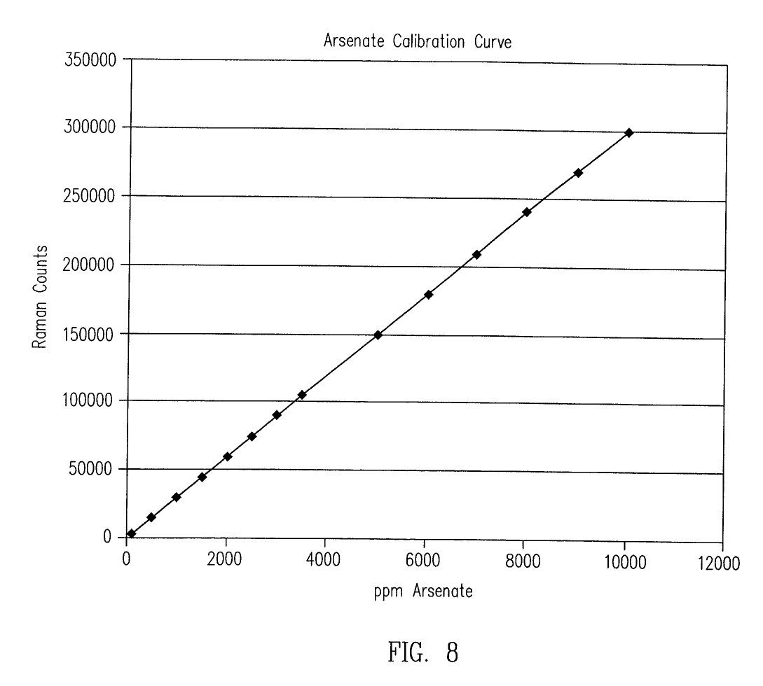

In a preferred embodiment of the present invention, an immersible probe 180 as illustrated in FIG. 7 is provided. The probe 180 includes an adjustable focal point 182 for incident light 122 provided by an excitation fiber 130 from a monochromatic light source 102 as shown in FIG. 3. The focal point 182 of the incident laser light is adjusted by moving an adjustable lens 184 within the probe body 186. The focal point 182 is adjusted such that it is within the sample subvolume immediately outside of a sealed probe window 190 through which the focused beam is projected. The close proximity of the beam focal point to the window—it is preferably in the range of approximately 0.1 to 5 mm from the outer surface of the window 190—mitigates potentially confounding effects of solution absorption and light scattering by particles on the collected Raman spectrum and subsequent analytical steps.

Spectral data collected via the aforementioned embodiments are preferably analyzed for features that can be ascribed to certain chemical species. The Raman shift of individual chemical species is preferably identified prior to analysis by separate measurement of individual components. Quantification of the individual components in a aqueous solution mixture is preferably achieved by determination of the peak area and/or height of the chemical species of interest, followed by comparison of these data to a straight-line calibration curve. The linear calibration curve is preferably generated by plotting peak area and/or height versus concentration of samples in which the concentration of the analyte of interest is known. Standard methods of statistical analysis including, but not limited to, linear regression may be applied to obtain a best fit straight line calibration curve. FIG. 8 shows an exemplary calibration curve generated by Raman analysis of known samples of a solution containing arsenic. Peak height and or area are collected for a series of standard solutions with varying concentrations. The data from these analyses are analyzed by linear regression to generate the calibration curve shown.

Commercially available software packages for spectral analysis may be used in conjunction with the above described system and method. These include Unscrambler by CAMO Technologies, Woodbridge, N.J. which is used to create calibration curves and goodness of fit metrics and to perform integration of peak areas and quantification of peak height. In addition, the software includes routines that eliminate extraneous effects that could have a negative impact on the area or peak height measurement, such as, for instance, fluorescence. Spectral software package for qualitative and quantitative analysis that include quantification of peak area and height are Unscrambler by CAMO and the GRAMS/AI package provided by Thermo Galactic, Salem, N.H. PLSplus/IQ, also provided by Thermo Galactic is used to perform partial least squares analyses on spectral data as is Unscrambler.

In a preferred embodiment of the present invention, a method is provided for calculating concentrations of individual additives and other analytes in a aqueous solution based on a single Raman spectrum captured as described above in the previous embodiments. The sample spectrum contains a plurality of peaks, some of which are attributable to Raman scattering by analytes of interest such as one or more aqueous solution additives. In general a spectrum of a solution containing multiple analytes has regions of the spectrum where peaks attributable to more than one analyte overlap. This embodiment of the present invention provides a method for deconvoluting a spectrum comprised of peaks from numerous analytes. Prior to analysis of a sample spectrum, standard spectra are prepared for each analyte expected to be found in the sample. A primary and one or more secondary peaks are identified for each standard. In general, the peak heights and/or areas of each of the primary and one or more secondary peaks vary linearly with the concentration of the analyte. As such, the ratios of the area and/or height of an individual secondary peak to the primary peak as well as to other secondary peaks in the spectrum of a single analyte are approximately constant and independent of the concentration of the analyte. This property is used in conjunction with standard spectra and peak ratios from the expected analytes to differentiate the concentrations of multiple overlapping analytes in a sample spectrum as follows. A region of the sample spectrum containing only a single primary or secondary peak from a first analyte is identified.

The concentration of that analyte is determined based on a calibration curve like the one shown in FIG. 8 based on the area and/or height of that peak in the standard spectrum. If, for example, a secondary peak from the first analyte occurs in the same region of the sample spectrum as the primary peak of a second analyte, the total area and/or height observed on the sample spectrum in the wavelength region of the primary peak of the second analyte is reduced by the expected height and/or area under the first analyte's secondary peak based on the concentration of the first analyte known from the primary peak height and/or area of the first analyte, the calibration curve, and the known ratio of the height and/or area of the primary and secondary peaks of the first analyte. This process is repeated as necessary to quantify all of the analytes of interest in a sample spectrum. Overlapping of multiple peaks from multiple analytes in a single wavelength region of a sample spectrum requires construction of a matrix of linear algebraic equations. The resulting matrix can be readily solved top identify the concentrations of each of the analytes by one of skill in the art provided that at least one peak of one analyte occurs alone in a discrete region of the spectrum.

Bilinear projection methods, like PCA (Principal Components Analysis), PCR (Principal Components Regression), PLS (Partial Least Squares regression, or Projection to Latent Structures regression) extract systematic information from the combination of many measurement variables. They also offer great interpretation features, to visualize sample patterns and variable relationships in easily interpretable graphical pictures. The multivariate models can then be used for indirect measuring, data reduction, exploration, prediction or classification/identification. These methods are easy to use and handle most multivariate problems despite intercorrelations, noise, errors, missing data, or extreme data table dimensions. Sub-routines and algorithms may also be used to streamline the data analysis process or for conversion of peak height or areas directly to additive concentrations.

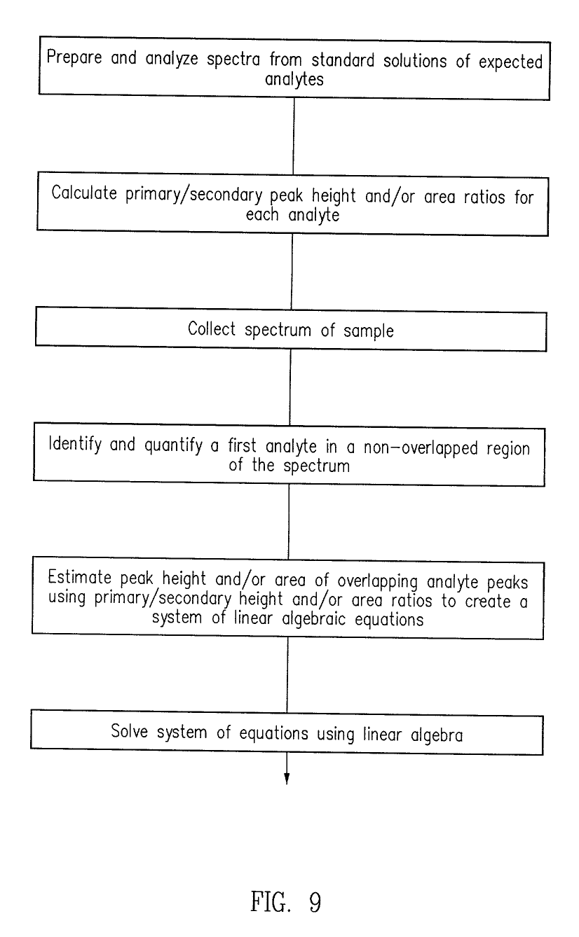

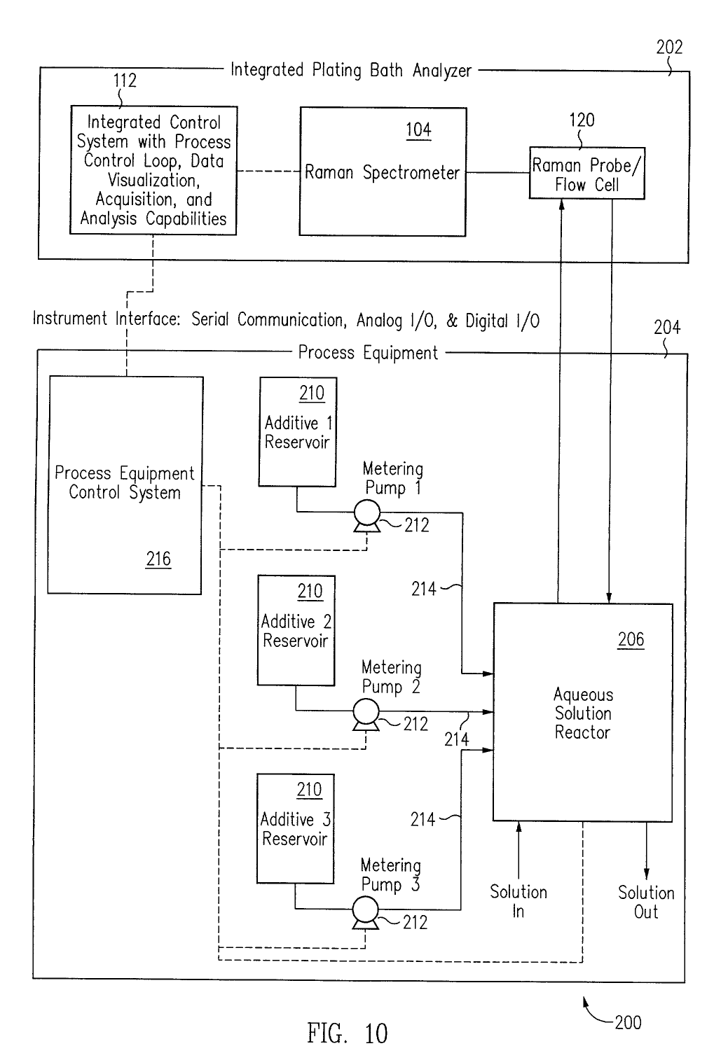

In a further embodiment of the present invention, the Raman analysis and aqueous solution additive concentration system and method are integrated with a commercially available chemical auto-dosing system to maintain the concentration of arsenic species and/or other chemical compounds of interest in a treated solution, such as for instance a waste water or potable water stream, below a maximum contaminant level or some similar upper limit. In this embodiment, the contaminant concentrations as well as those of one or more treatment additives such as for instance ferric hydroxide are maintained within acceptable ranges during an ongoing, dynamic process. In this embodiment, shown schematically in FIG. 9, an integrated aqueous solution analyzer system 200 maintains the proper concentrations of treatment additives in an aqueous solution by providing a feedback signal from a Raman spectroscopy system to an autodosing system to control the rates at which selected additives are added to the aqueous solution. In this embodiment, an analyzer subsystem 202 interfaces with a process subsystem 204 to provide chemical concentration data as well as control capability.

In general, an aqueous solution reactor 206 contains a solution comprising one or more contaminants including arsenic discharged from an industrial process and/or provided as influent to a water treatment process. The contaminant concentrations in the solution flow input to the system of the present invention are non-constant. However, outflows from the system of the present invention are maintained at contaminant concentrations below preset, programmed limits. Maintaining the concentration level of the contaminants in the solution, is essential in controlling the process. Typically, the aqueous solution reactor 206 and the additive metering hardware are a part of the process subsystem. However, it is not a requirement.

The analyzer subsystem 202 includes a spectrograph 104 including a fiber input and CCD array (not shown in FIG. 9) as described above. The spectrograph is preferably connected to a personal computer based control system 112 with control electronics for processing the signals received and quantified by the spectrograph and CCD array. The computer system 112 preferably consists of a computer, a CCD controller card that plugs into the computer mother board, communication PC cards such as a modem and an Ethernet card among others, and digital and analog input/output ports.

One or more additives supplied from one or more additive reservoirs 210 are metered into the aqueous solution reactor 206 via metering pumps 212 to maintain the required concentration levels of the additives and the one or more contaminants. In this embodiment, the concentrations of contaminants and additives are monitored via Raman spectroscopy as outlined in the preceding embodiments. These data are used to safe guard against discharge of the aqueous solution with contaminant concentrations that exceed the prescribed limits. Additives are supplied to the aqueous solution reactor 206 via supply lines 214 from the additive reservoirs at rates metered by the metering pumps 212 based on feedback received from the analyzer subsystem 202. In this closed-loop control scheme, the concentrations of key components of the aqueous solution are tightly controlled without dependence on empirical relationships or historical data regarding contaminant concentrations in the input aqueous solution. As a treatment additive is added into the aqueous solution via any control and metering process, the concentration of that additive is at its peak and similarly the removal rate of the contaminant to be treated by the additive is at its highest. The additive concentration gradually decreases over time during processing. The amplitude of the additive concentration variability can theoretically be minimized by supplying a continuous, uniform addition of additives to the aqueous solution reactor 206. However, because real process conditions and the influent concentration of the contaminants whose removal depletes the additive concentrations are never ideal or constant, constant corrections of the addition rate are necessary. Analyzer subsystem 202 provides continuous feedback to a process subsystem controller 216 that in turn controls the metering pumps 212 to adjust the delivery rate of the additives from the reservoirs 210 to the aqueous solution reactor 206. The process subsystem controller 216 has built in algorithms and hardware inputs and outputs to directly control the additive metering pumps 212.

The system and method provided by this embodiment is capable of directly controlling the metering pumps 212 or transmitting data on the concentrations of additives and byproducts.

The aforementioned embodiments of the system and method of the present invention are directed to analysis of aqueous solution additives in industrial and potable waters. In an alternative embodiment, the system and method of the present invention are applied to analysis of arsenic in aqueous solutions.

### Experimental

A number of experiments were conducted according the method and system of the present invention. These experiments are intended for illustration purposes only, and are not intended to limit the scope of the present invention in any way.

### EXAMPLE 1

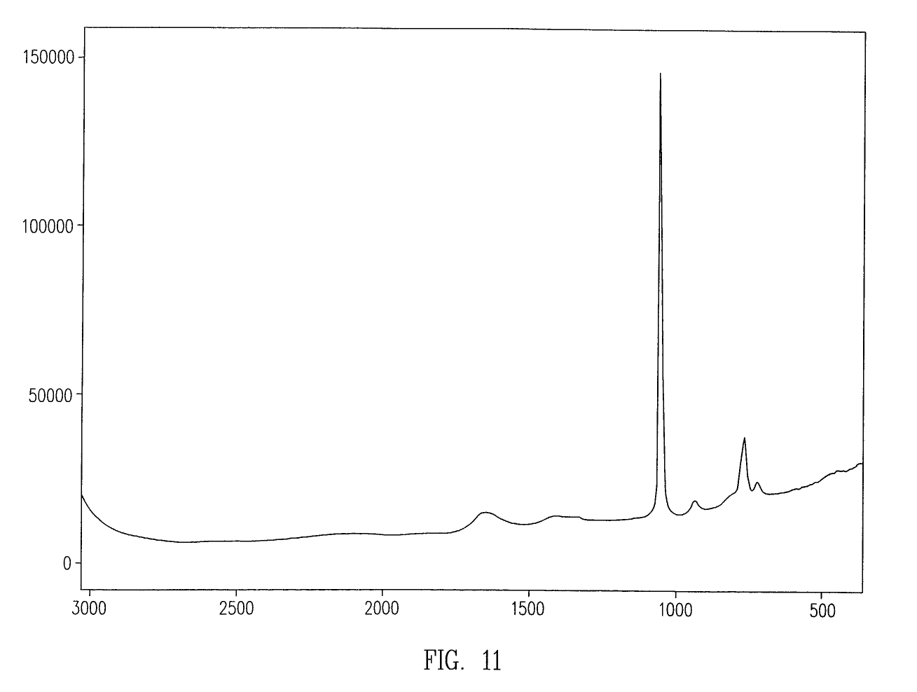

In one example, standard samples containing aqueous arsenic were tested. The concentration range was 100 ppm to 10,000 ppm. FIG. 10 shows the linear calibration curve generated for the standard samples. This plot shows that peak area/height is a linear function of concentration. Raman spectra of aqueous arsenic are shown is shown in figures y and z. The arsenic signals are identified at approximately 930 and 766 wavenumbers. The signals at approximately 1040 and 718 wavenumbers are from the nitrate anion.

### EXAMPLE 2

In another experimental example, a sample of wastewater containing an unknown amount of arsenic was measured. It was found that the solution contained 10,000 ppm of arsenic. The system used to analyze the aqueous solution is as described above and depicted schematically in FIG. 3. A 532 nm, 84 mW green Nd:YAG laser was used in conjunction with a fixed probe head as described above. The system integrates an internal laser calibration system based on an internal neon discharge. This enables greater measurement precision and a discrete non-varying laser output. The result is greater repeatability and more consistent peak areas. A thermoelectrically cooled CCD detector of the dimensions 1024×128 was used. The spectral resolution is 4 cm⁻¹. The bandwidth of analysis was 400 to 3000 cm⁻¹. A personal computer running commercially available spectral analysis software packages (Unscrambler by CAMO Technologies and GRAMS/AI and PLSplus/IQ by Thermo Galactic) were used for data analysis and peak height and area determination. A 3 mL sample was withdrawn from the aqueous solution and a placed in a borosilicate glass vial. Acquisition times varied from approximately 1 to 10 minutes. Based on comparison of the aqueous solution emission spectrum to known controls and a standard calibration curve, it was determined that the data thus obtained was consistent with the arsenic concentration measured by atomic emission spectroscopy.

### EXAMPLE 3

In a further experimental example of the present invention, an aqueous solution containing arsenic was analyzed using a 785 nm Raman system. To compensate for the approximately fourfold reduction in sensitivity at this wavelength versus 532 nm as predicted by equation 5, the incident laser power was boosted to 150 mW. As noted above, Raman signal sensitivity is a linear function of power.

An aqueous solution containing arsenate ion was analyzed using a quartz cell with a Renishaw Ramascope Raman System 1000 coupled to an Leica DMLM microscope. The system is equipped with diode laser excitation (785 nm., 150 mW of power), a entrance slit of 50 microns, an 1800 groves/mm high efficiency aluminized grating, and a high sensitivity thermoelectrically cooled CCD detector. The Raman spectra for reference areas were collected on adjacent clear field areas. Raman spectra are collected at 4 cm⁻¹ resolution from 200 to 3600 cm⁻¹, on liquid samples ranging from 300 microliter to 1 liter volumes. Under these conditions, an acquisition time of one minute was sufficient to generate spectral data for calibration and unknown analysis with less than 1% error.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

What is claimed is:

1. A Raman spectroscopy system for quantifying concentrations of one or constituents in an aqueous solution comprising:
a laser light source providing incident monochromatic light at a chosen wavelength, said wavelength being selected to fall within a region of low light absorbance on the ultraviolet-visible light absorbance spectrum for said solution;
a detector which quantifies the area under said peaks as a function of wavelength for detecting a solution emission spectrum of Raman scattered light from said solution;
a probe assembly comprising an immersible head and a probe window that is transparent to said chosen wavelength, said immersible head being immersed in a subvolume containing a sample of said solution such that said probe window is completely submerged to exclude ambient light for receiving Raman scattered light and transmitting to said detector; and
a spectrum processor configured to determine concentrations of each of said solution constituents by deconvolution of said peaks in said solution emission spectrum of Raman scattered light based on one or more pre-calculated ratios of the areas under a plurality of peaks in standard emission spectra for each of said solution constituents.

2. The Raman spectroscopy system of claim 1 further comprising:
at least a first fiber optic cable for transmitting said incident monochromatic light from said source to said immersible head and therefrom through said probe window into said subvolume to produce said solution emission spectrum of Raman scattered light with peaks at one or more scattered wavelengths, and at least a second fiber optic cable for transmitting said Raman scattered light passing into said immersible head through said probe window to said detector.

3. The system of claim 1 wherein said detector further comprises:
a CCD receiver and a processor housed together and spaced apart from said laser source, said CCD receiver including a plurality of diode cells formed in a linear array, for receiving said Raman scattered light and wherein each of said diode cells exhibit output signals corresponding to the amount of received scattered light; and
said processor for receiving said output signals and generating a measurement signal corresponding to said output signals of said plurality of diode cells.

4. The Raman spectroscopy system of claim 1 wherein said immersible head is constructed of one or more acid-resistant materials.

5. The Raman spectroscopy system of claim 1 wherein said probe window is a lens and said lens adjusts the focal point of said incident monochromatic light directed from said immersible head into said subvolume such that the penetration depth of said incident monochromatic light into said subvolume of said solution is in the range of approximately 0.1 mm to 1 cm.

6. The Raman spectroscopy system of claim 1 further comprising one or more pumps, said pumps continuously circulating the solution through said subvolume so that said emission spectrum is representative of said solution as a whole.

7. The Raman spectroscopy system of claim 1 in which said source of incident monochromatic light is a diode laser.

8. The Raman spectroscopy system of claim 7 wherein said diode laser provides incident light at a wavelength in the range of approximately 340 to 550 nm.

9. The Raman spectroscopy system of claim 6 wherein said diode laser provides incident light at a wavelength of approximately 532 nm.

10. A method for quantifying concentrations of one or more constituents in an aqueous solution comprising the steps of:
individually collecting a standard Raman emission spectrum in response to monochromatic light at a chosen wavelength for each of said one or more solution constituents, said wavelength being selected to fall within a region of low light absorbance on an ultraviolet-visible light absorbance spectrum collected for said solution;
identifying a ratio of peak areas between each of the resultant peaks in said one or more standard emission spectra;
providing incident monochromatic light at said chosen wavelength from a monochromatic light source to said solution containing one or more solution constituents;
detecting said light emitted by Raman scattering in said solution on a light detector;
converting said detected emitted light into a solution emission spectrum; and
analyzing said solution emission spectrum to quantify the concentrations of said one or solution constituents by creating a series of coupled linear equations in which the concentrations of said one or more solution constituents are unknowns and said peak area ratios are knowns and solving said set of linear equations using linear algebra.

11. The method of claim 10 further comprising the step of:
adjusting the focal point of said incident monochromatic light such that its penetration depth into said solution is in the range of approximately 0.1 mm to 1 cm.

12. A method for determining concentrations of a plurality of analytes from a spectrum collected for a sample containing said analytes comprising the steps of:
preparing and analyzing a standard spectrum for each of said analytes;
calculating a ratio of a primary peak metric to a secondary peak metric for each analyte based on said standard spectra;
collecting a sample spectrum of said sample;
identifying and quantifying a first of said plurality of analytes in a region of said sample spectrum;
estimating a peak metric attributable to each of one or more of said plurality of analytes with a peak in an overlapping region of said sample spectrum based on said primary/secondary peak metric ratios;
creating a system of coupled linear algebraic equations based on said estimated peak metrics; and
solving said system of coupled linear algebraic equations using linear algebraic techniques.

13. A chemical auto-dosing system for controlling the concentration of one or more solution constituents in an aqueous solution comprising:
a Raman spectroscopy probe that interfaces with said solution;
one or more additive reservoirs each containing one of said one or more solution constituents;
one or more metering pumps that control the flow of said solution constituents from said reservoirs to said plating solution;
a Raman spectrometer coupled to said Raman probe for quantifying a Raman spectrum emitted from said solution and collected by said probe;
an analyzer subsystem controller that processes said Raman spectrum to determine real time concentrations of said solution constituents in said solution; and
a processing subsystem controller that receives and processes concentration data from said analyzer subsystem controller to provide control outputs to said metering pumps.
